(19) United States
(12) Patent Application Publication
(10) Pub. No.: US 2003/0049186 A1
(43) Pub. Date: Mar. 13, 2003

(54) Device for the selective oxidation of a process stream

(75) Inventors: Wolfram Birk, Wendlingen, DE (US); Sven Erdmann, Ulm (DE); Stefan Neher, Suessen (DE); Carlo Saling, Wolfschlugen (DE); Matthias Wolfsteiner, Kirchheim/Teck (DE)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems AG, Kirchheim-Nabern (CA)

(21) Appl. No.: 10/216,102

(22) Filed: Aug. 8, 2002

(30) Foreign Application Priority Data
Aug. 8, 2001 (DE) 10139046.7

(51) Int. Cl. B01J 8/02

(52) U.S. Cl. 422/222; 422/224

(57) ABSTRACT

A plate-type selective oxidation device, for the selective oxidation of constituents of a process stream, contains a media chamber located between two plates of the device. Each media chamber contains fins or ridges for the input or dissipation of thermal energy and/or to selectively direct the process stream. In partial areas of each media chamber, the fins or ridges are thermally decoupled from the plates that border the respective media chamber, to facilitate cold start-up of the device.

### CROSS-REFERENCE TO RELATED APPLICATION

This application claims priority to German Patent Application No. 10139046.7, which application is hereby incorporated by reference in its entirety.

### BACKGROUND OF THE INVENTION

1. Field of the Invention

The invention is generally directed to a device, with a plate design, for the selective oxidation of constituents of a process stream.

2. Description of the Related Art

EP 0 687 648 A1 describes a reactor with a plate design. The individual plates of the reactor are separated by corrugated fins or ridges. Within the respective media chambers, the fins or ridges form structures that serve as supports, direct flow and aid in thermal conduction. The plates, as well as the fins or ridges, may be coated with a catalyst. Reactors of this type with a plate design are commonly used because of their advantages with respect to simple dimensioning, compactness and the possibility to thermally control the processes in the reactor by arranging media chambers, as well as cooling and heating chambers, next to each other.

Also commonly used are devices or reactors for the selective oxidation of constituents of a process stream, for example for the selective oxidation of carbon monoxide as part of the gas purification in a gas purification system, in particular in fuel cell systems. Such devices or reactors are equipped with catalysts, which generally require a comparatively high temperature level for activation and proper operation. For the oxidation of carbon monoxide, in particular by means of noble metal catalysts, this temperature level lies between approximately 200° C. and 300° C.

To start the operation of such a selective oxidation device from a very low temperature, for example from a temperature range between approximately −25° C. and +25° C., takes a comparatively long time before the device reaches its proper operating state. This is a serious disadvantage, especially if such devices are to be used for the selective oxidation of carbon monoxide in a reactant stream in gas generation systems for fuel cell powered motor vehicles. Users of such motor vehicles will not accept long start-up times, yet it is necessary to carry out the gas purification in accordance with specifications to prevent residual amounts of carbon monoxide in the generated gas stream from damaging the fuel cell.

Accordingly there remains a need for selective oxidation devices or reactors that overcome the disadvantages of the devices and reactors designed to date, in particular the disadvantages associated with a long cold start-up time. The present invention fulfills one or more of these needs, and provides further related advantages.

### BRIEF SUMMARY OF THE INVENTION

In brief, this invention is directed to devices and systems for the selective oxidization of constituents of a process stream.

In one embodiment, a selective oxidation device, with a plate design, is disclosed. The device comprises a media chamber arranged between two plates of the device, and fins or ridges within the media chamber, wherein in partial areas of the media chamber, the fins or ridges are thermally insulated from at least one of the two plates that border the media chamber.

In another embodiment, the selective oxidation device comprises a media chamber arranged between two plates of the device, fins or ridges within a first portion of the media chamber and fibrous non-woven or foam materials within a second portion of the media chamber.

In yet another embodiment, the selective oxidation device comprises a media chamber arranged between two plates of the device, and fins or ridges within the media chamber, wherein in partial areas of the media chamber, the fins or ridges have a lower wall thickness than in other areas of the media chamber.

In further embodiments, a gas generation system of a fuel cell system comprising the device of this invention, as well as a motor vehicle comprising the same, are disclosed.

These and other aspects of this invention will be apparent upon reference to the attached figures and following detailed description.

### BRIEF DESCRIPTION OF THE DRAWINGS

FIG. 1 shows a cross-sectional view of a representative selective oxidation device.

FIG. 2 shows a cross-sectional view, along the line II-II of FIG. 1, of a representative selective oxidation device.

FIG. 3 shows a cross-sectional view, along the line II-II of FIG. 1, of an alternate representative selective oxidation device.

FIG. 4 shows a cross-sectional view, along the line II-II of FIG. 1, of an alternate representative selective oxidation device.

FIG. 5 shows a cross-sectional view, along the line II-II of FIG. 1, of an alternate representative selective oxidation device.

FIG. 6 shows a cross-sectional view, along the line II-II of FIG. 1, of an alternate representative selective oxidation device.

FIG. 7 shows a cross-sectional view, along the line II-II of FIG. 1, of an alternate representative selective oxidation device.

FIG. 8 shows a cross-sectional top view of a representative selective oxidation device 1.

FIG. 9 shows a cross-sectional top view of an alternate representative selective oxidation device 1.

### DETAILED DESCRIPTION OF THE INVENTION

As noted above, this invention is directed to a device, with a plate design, for the selective oxidation of constituents of a process stream.

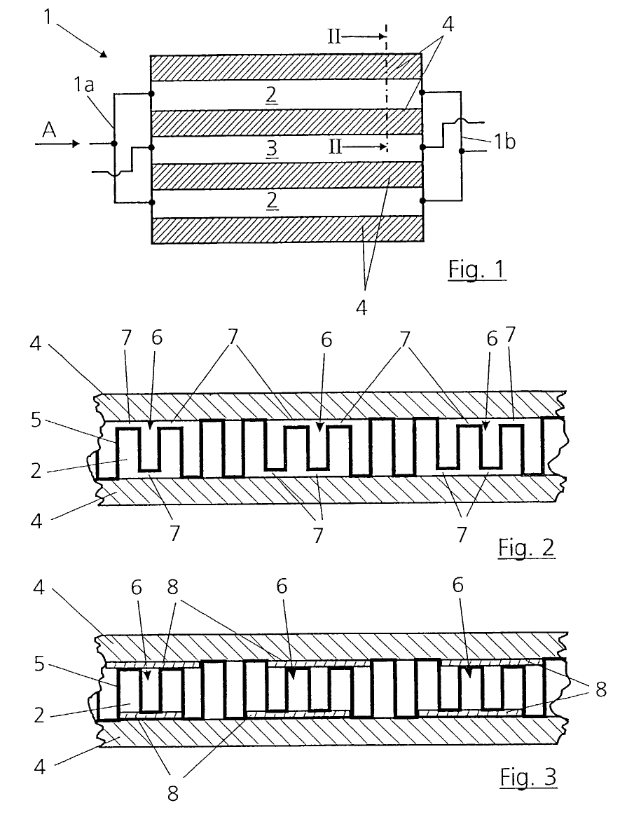

FIG. 1 shows a cross-sectional view of a representative plate-type selective oxidation device 1. The process stream A travels from an intake area 1a through media chambers 2, each of which are positioned between two plates 4, to a discharge area 1b of device 1. A heating or cooling medium flows in a well-known manner through a heating or cooling chamber 3, which is positioned between two plates 4 and which is located between a pair of media chambers 2. The alternating structure of media chambers 2 and heating or cooling chambers 3 can continue outside of the shown area.

The cooling, which is effected by a cooling medium flowing through the cooling chamber 3, may be suspended during a cold-start phase. However, it is also possible for the cooling medium to flow through device 1 during the cold-start phase, so that heat from a location in cooling chamber 3, for example a location at which the reaction commences earlier, can be transported to other areas, in which the heat is needed to heat the component because the reaction has not yet started in these other areas. For example, it is possible to wait for a short time period until reaction heat has been generated in one area of device 1 before one turns on the cooling medium flow to distribute this heat through the entire device 1. This can even out the distribution of thermal energy. Conventional cooling then takes over during standard operation of device 1.

FIG. 2 shows a cross-sectional view along line II-II of FIG. 1 of a representative media chamber 2 of FIG. 1, which is positioned between two plates 4. Media chamber 2 contains fins or ridges 5, which in this embodiment are corrugated structures in media chamber 2. The catalyst required for the selective oxidation may be applied onto the faces of plates 4 bordering media chamber 2 and/or onto fins or ridges 5.

FIG. 2 also shows that in partial areas 6 of media chamber 2, fins or ridges 5 are thermally decoupled from plates 4 by a gap 7. Accordingly, there is poor conduction of thermal energy, which accumulates in partial areas 6, to plates 4. In these areas less heat is being dissipated to plates 4 and thus the entire frame structure of device 1 of FIG. 1, which leads, at least in these partial areas 6, to a more rapid heating of media chamber 2 and the catalyst contained therein. As a result, activation of the catalyst, and thus the resulting selective oxidation, can commence earlier than in a case in which all fins or ridges are thermally coupled to the plates and directly transfer their heat to these plates. This significantly shortens the cold-start time of device 1 of FIG. 1.

FIG. 3 shows a cross-sectional view along line II-II of FIG. 1 of an additional representative media chamber 2 of FIG. 1, in which an insulating layer 8 is placed between fins or ridges 5 and plates 4, instead of a gap 7 as in FIG. 2. Similar to the effect of gap 7 of FIG. 2, insulating layer 8 prevents, at least in partial areas 6, a direct dissipation of thermal energy from fins or ridges 5 to plates 4. In an alternate embodiment, insulating layer 8 could be extended throughout the entire area of plate 4, however this configuration could result in thermal problems during regular operation (e.g., after a cold-start phase of device 1 of FIG. 1). If an insulating layer 8 is used across the entire surface of plate 4, then the structure will require a means to establish a connection between plates 4 and fins or ridges 5, for example by soldering or a similar process, to ensure the structural integrity of device 1 of FIG. 1.

Insulating layer 8 may consist of foam materials, such as materials that are generally used for insulating layers with high thermal loads (e.g. ceramics or similar materials) or metallic materials, such as porous fibrous non-woven materials or comparable materials, whereby the function of the materials in insulating layer 8 is to be a poor heat conductor between fins or ridges 5 and plates 4. Attention should be paid to the thermal stability of the material that is used for insulating layer 8 because of the high temperatures that can arise in device 1 of FIG. 1, which, as mentioned above, can reach approximately 200° C. to 300° C. during regular operation after a cold-start phase.

In one embodiment of the representative media chamber 2 of FIG. 3, insulating layer 8 is executed as a coating on the surfaces of plates 4 that face media chamber 2. In an alternate embodiment, insulating layer 8 is executed as a matting, which during manufacturing may be placed in partial areas 6.

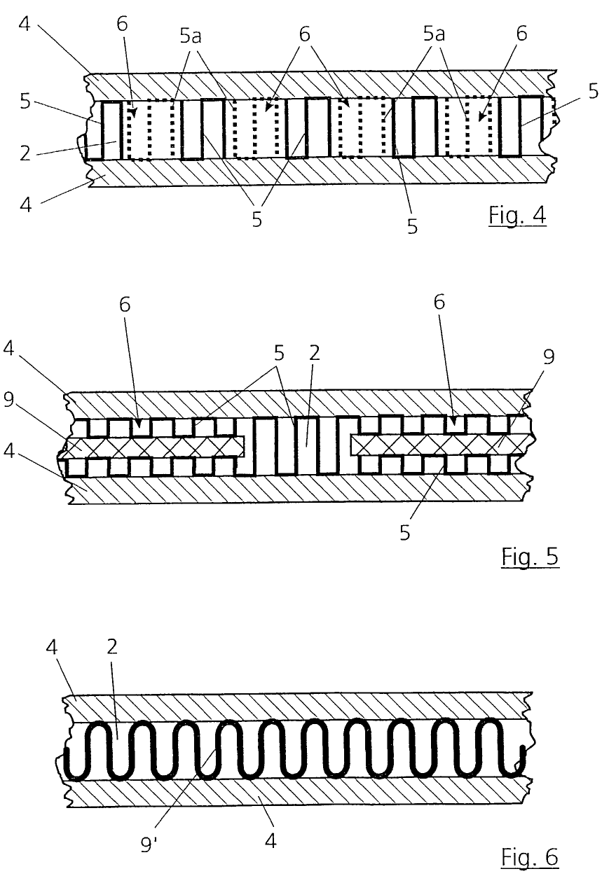

FIG. 4 shows a cross-sectional view along line II-II of FIG. 1 of an additional representative media chamber 2 of FIG. 1. In partial areas 6, fins or ridges 5 are shown as fins or ridges 5a made from a material with poor thermal conductivity, in particular as ceramic fins 5a. Due to mechanical requirements, fins or ridges 5a may possess a different design and shape than the neighbouring fins 5 and a person of ordinary skill in the art will be able to select a suitable design for a given application. As in FIG. 2, the catalyst required for the selective oxidation of the constituents of the process stream may be applied onto the faces of the plates bordering the media chamber and/or onto fins or ridges 5 and 5a. Fins or ridges 5a, which have a poorer thermal conductivity than comparable metallic fins, achieve an effect similar to that of the thermal decoupling of partial areas 6 from plates 4 by means of gap 7 of FIG. 2 or insulating layer 8 of FIG. 3.

FIG. 5 shows a cross-sectional view along line II-II of FIG. 1 of an additional representative media chamber 2 of FIG. 1, in which in partial areas 6 of media chamber 2, portions of fins or ridges 5 are replaced by fibrous non-woven or foam materials 9, which will be referred to herein as insulating materials 9. These insulating materials 9 are responsible for poor thermal conduction in this area. They may be, for example, metallic or ceramic materials and can be coated with a catalyst.

In comparison to fins or ridges 5, heat conduction from insulating materials 9 to the surrounding fins or ridges 5 or to plates 4 is much poorer. The area around insulating materials 9 (which may be, for example, a thin wire fabric or as a foam metallic or ceramic material with a thin wall thickness between its pores), heats up much more rapidly on account of poor thermal conductivity of the insulating material. Consequently, media chamber 2 heats up much more rapidly in partial areas 6 than in the other areas.

Since insulating materials 9 do not dissipate heat as fast as fins or ridges 5, a thermal layer is formed rather rapidly within insulating materials 9 and this thermal layer rapidly achieves a temperature level sufficiently high for the catalytic coating of insulating materials 9 to be active. Consequently, the area surrounding insulating materials 9 contains active zones of the catalytic coating in which, during a cold-start phase, the desired selective oxidation processes can take place at a very early time. This significantly shortens the time period necessary for a cold-start of device 1 of FIG. 1.

One disadvantage of insulating materials 9 is that they can cause a pressure drop when a process stream passes through them. For this reason, the configuration of FIG. 5 is very practical, since it can achieve an optimization of the cross-sectional area of insulating materials 9 and fins or ridges 5, which are arranged between insulating materials 9, and, in partial areas 6, between insulating materials 9 and plates 4, so that a very short cold-start time may be achieved with a comparatively small increase of the overall pressure drop of device 1 of FIG. 1.

FIG. 6 shows a cross-sectional view along line II-II of FIG. 1 of an additional representative media chamber 2 of FIG. 1, in which the process stream does not flow through portions of insulating materials 9, as is the case in the embodiment of FIG. 5, but only flows over these parts, which results in a significantly lower pressure drop. In media chamber 2 of FIG. 6, an insulating material 9′, which may be in the form of a metallic or ceramic fibrous non-woven material, for example, in the shape of a corrugated sheet metal is placed in media chamber 2.

As described previously, due to the design of insulating materials 9′, the insulating materials will heat up more rapidly and the thermal coupling to plates 4 will be comparatively poor. In the configuration shown in FIG. 6, the process stream passing through media chamber 2 passes by insulating materials 9′ resulting in a lower pressure drop than in the configuration in which the process stream passes through insulating materials 9′, as is at least partially the case in the configuration of FIG. 5.

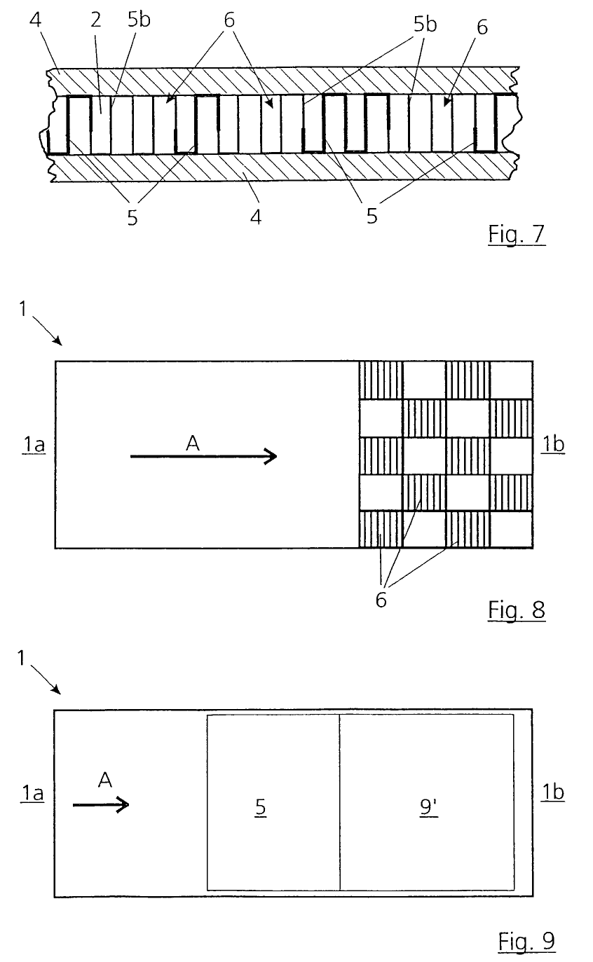

FIG. 7 shows a cross-sectional view along line II-II of FIG. 1 of an additional representative media chamber 2 of FIG. 1, in which in partial areas 6, fins or ridges 5b have a lower wall thickness than fins or ridges 5 in the other areas of media chamber 2, for example fins or ridges 5b may have a thickness of 30 to 50% of the thickness of fins or ridges 5. This leads to effects similar to those described previously with respect to the thermal decoupling of partial areas 6, since fins or ridges 5b, with a lower wall thickness, have poorer heat conduction than that of fins or ridges 5 in the other areas of media chamber 2. As before, this leads to a more rapid heating of partial areas 6 during a cold-start phase, and consequently to a significant shortening of the cold-start time of device 1 of FIG. 1.

FIG. 8 shows a cross-sectional top view of a representative device 1 for the selective oxidation of constituents of a process stream. With respect to the flow direction of the process stream A, which flows from intake area 1a to discharge area 1b of device 1, partial areas 6 are located in the half of device 1 that is closer to discharge area 1b, in particular in the last third, with respect to the flow direction, of device 1. Accordingly, during regular operation of device 1, the largest portion of the selective oxidation processes will occur in the intake area 1a. Regular operation in a motor vehicle, usually takes place under partial load conditions, consequently only very small amounts of selectively oxidizable substances will reach partial areas 6 during regular operation after a cold-start phase. Since under regular operation only a comparatively small amount of selectively oxidizable substances reaches partial areas 6, a successful balance between a significant shortening of the cold-start time and the thermal load on device 1, in particular in partial areas 6, may be achieved during the predominant portion of regular operation. As a result, disadvantages such as an overheating of the catalytic material in device 1 or of device 1 itself may be avoided.

Furthermore, FIG. 8 shows a checker-board-like arrangement of partial areas 6 and other areas, which achieves a desirable combination of heat dissipation and heat retention in which process stream A cannot bypass partial areas 6. Moreover, such a checker-board-like arrangement may also improve the mechanical stability of the structure of device 1, in particular, the plate design.

When using an insulating layer, such as insulating layer 8 of FIG. 3, that may be in the form of a continuous coating, such a coating may be applied, for example, to the last third, with respect to the flow direction, of device 1. The thickness of such a coating of an insulating layer may also increase along the flow direction.

FIG. 9 shows a cross-sectional top view of an alternate representative selective oxidation device 1. In the configuration of FIG. 9, process stream A first passes through fins or ridges 5, which may be in the form described in FIGS. 2 through 7 above. Process stream A then passes through an area that contains the corrugated-sheet-metal-like insulating materials 9′ of FIG. 6. This configuration creates a structure that changes along the flow path of process stream A, whereby the heat coupling to the plates (i.e. plates 4 of FIGS. 1 through 7 above) changes as the process streams through media chamber 2.

From the foregoing it will be appreciated that, although specific embodiments of the invention have been described herein for purposes of illustration, various modifications may be made without deviating from the spirit and scope of the invention. Accordingly, the invention is not limited except as by the appended claims.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

1. A plate-type selective oxidation device, for the selective oxidation of constituents of a process stream, comprising:
a media chamber arranged between two plates of the device; and
fins or ridges within the media chamber,
wherein in partial areas of the media chamber, the fins or ridges are thermally insulated from at least one of the two plates that border the media chamber.

2. The device of claim 1 wherein the fins or ridges are thermally insulated from the two plates by means of a gap between the fins or ridges and the two plates.

3. The device of claim 1 wherein the fins or ridges are thermally insulated from the two plates by means of an insulating layer between the fins or ridges and the two plates.

4. The device of claim 3 wherein the insulating layer comprises a coating.

5. The device of claim 3 wherein the insulating material comprises a matting.

6. The device of claim 3 wherein the insulating layer comprises a foam material.

7. The device of claim 3 wherein the insulating layer comprises a ceramic material.

8. The device of claim 1 wherein the fins or ridges are thermally insulated from the two plates by incorporating in the partial areas of the media chamber fins or ridges comprised of ceramic materials.

9. A plate-type selective oxidation device, for the selective oxidation of constituents of a process stream, comprising:
a media chamber arranged between two plates of the device;
fins or ridges within a first portion of the media chamber; and
fibrous non-woven or foam materials within a second portion of the media chamber.

10. The device of claim 9 wherein the fibrous non-woven or foam materials have a catalytic coating.

11. The device of claim 9 wherein the fibrous non-woven or foam materials comprise a metal foam.

12. The device of claim 9 wherein the fibrous non-woven or foam materials comprise a metal fibrous non-woven material.

13. The device of claim 9 wherein the fibrous non-woven or foam materials comprise a ceramic foam.

14. A plate-type selective oxidation device, for the selective oxidation of constituents of a process stream, comprising:
a media chamber arranged between two plates of the device; and
fins or ridges within the media chamber,
wherein in partial areas of the media chamber, the fins or ridges have a lower wall thickness than in other areas of the media chamber.

15. The device of claim 1, 9 or 14 wherein the fins or ridges have a catalytic coating.

16. The device of claim 1, 9 or 14 wherein the partial areas of the media chamber are located in the second half, with respect to the flow direction of the process stream through the media chamber.

17. The device of claim 1, 9 or 14 wherein the partial areas of the media chamber are located in the last third, with respect to the flow direction of the process stream, of the media chamber.

18. The device of claim 1, 9, or 14, further comprising a cooling chamber, wherein the cooling chamber is arranged between one of the two plates that border the media chamber and a third plate of the device.

19. A gas generation system for a fuel cell system comprising the device of claim 1, 9 or 14.

20. A motor vehicle comprising the gas generation system of claim 19.
